(19) United States
(12) Patent Application Publication
(10) Pub. No.: US 2024/0265925 A1
(43) Pub. Date: Aug. 8, 2024

(54) Systems and Methods for Language Identification in Audio Content

(71) Applicant: Spotify AB, Stockholm (SE)

(72) Inventors: Xingran Zhu, Stockholm (SE); Md Iftekhar Tanveer, Revere, MA (US); Yang Janet Liu, Washington, DC (US); Rosemary Ellen Jones, Cambridge, MA (US); Oluseye Ojumu, Brooklyn, NY (US)

(21) Appl. No.: 18/165,817

(22) Filed: Feb. 7, 2023

(51) Int. Cl. G10L 17/18; G10L 17/02; G10L 21/028

(52) U.S. Cl. CPC G10L 17/18; G10L 17/02; G10L 21/028

(57) ABSTRACT

The various implementations described herein include methods and devices for identifying a language in audio content. In one aspect, a method includes obtaining audio content and generating a speaker embedding from the audio content. The method further includes determining, via a language identification model, a language of the audio content based on the speaker embedding.

### RELATED APPLICATIONS

This application is related to U.S. patent application Ser. No. 17/932,249, entitled “Systems and Methods for Speaker Diarization,” filed Sep. 14, 2022, which is hereby incorporated by reference in its entirety.

### TECHNICAL FIELD

The disclosed embodiments relate generally to language identification including, but not limited to, using speaker embeddings to identify languages in audio content.

### BACKGROUND

Recent years have shown a remarkable growth in consumption of digital goods such as digital music, movies, books, and podcasts, among many others. The overwhelmingly large number of these goods often makes navigation of digital goods an extremely difficult task.

Language identification has a wide range of applications and is an important step in various speech processing systems, such as automatic speech recognition (ASR) and speech translations. However, for podcasts and other conversational audio items, it can be particularly challenging to detect the primary language and/or where different languages are spoken. The challenge increases with increasing numbers of speakers having different pronunciations and/or dialects, particularly if the speakers interrupt and/or speak over one another.

Additionally, spoken language identification (SLI) systems have traditionally been trained on audio language classification datasets composed of short audio clips (e.g., a few seconds in duration). Thus, conventional SLI systems are built towards classifying short-form speech content. Long-form audio (e.g., several minutes or hours in duration), such as podcasts, are challenging for such systems because long-form audio is generally sparser in speech and can include a variety of additional non-speech content (e.g., silence, music, and laughter).

### SUMMARY

Spoken language identification is the task of identifying spoken language(s) from an audio input. Many speech processing systems (e.g., automatic speech recognition and speech translation) require language labels as a prerequisite for audio speech processing. Currently, the language labels are mostly provided manually, and thus the ability to automatically identify the language labels from audio-only input increases the scalability of existing speech processing systems.

The present disclosure describes using speaker embeddings with an identification model to predict language labels. The systems and methods described herein obtain speaker embeddings from audio input (e.g., without requiring a denoising step). The speaker embeddings can then be input to a language identification model (e.g., a feedforward neural network) to predict the spoken language(s). In this way, the systems and methods described herein can identify a spoken language from long audio content (e.g., a 30-minute audio podcast) rather than only short utterances (e.g., 10 seconds snippets). Additionally, the systems and methods described herein are effective and accurate in spoken language identification on a wide range of languages and speech styles (e.g., monologic and conversational, scripted and impromptu, narrative and discussive, etc.).

In accordance with some embodiments, a method of identifying a language in audio content is provided. The method is performed at a computing device having one or more processors and memory. The method includes: (i) obtaining audio content; (ii) generating a speaker embedding from the audio content; and (iii) determining, via a language identification model, a language of the audio content based on the speaker embedding.

In accordance with some embodiments, a computing system is provided. The computing system includes one or more processors and memory storing one or more programs. The one or more programs include instructions for performing any of the methods described herein (e.g., the method 700).

In accordance with some embodiments, a non-transitory computer-readable storage medium is provided. The non-transitory computer-readable storage medium stores one or more programs for execution by a computing system with one or more processors. The one or more programs comprising instructions for performing any of the methods described herein (e.g., the method 700).

Thus, devices and systems are disclosed with methods for language identification from audio content. Such methods, devices, and systems may complement or replace conventional methods, devices, and systems for language identification from audio content.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is a block diagram illustrating a media content delivery system in accordance with some embodiments.

FIG. 2 is a block diagram illustrating an electronic device in accordance with some embodiments.

FIG. 3 is a block diagram illustrating a media content server in accordance with some embodiments.

FIG. 4 is a block diagram illustrating a language identification system in accordance with some embodiments.

FIG. 5 illustrates a user interface for media content in accordance with some embodiments.

FIG. 6 is a block diagram illustrating an embedding signal in accordance with some embodiments.

FIG. 7 is a flow diagram illustrating a method of language identification in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

A podcast can contain a rich affordance of audio content but poses significant challenges to SLI due to its diverse speech styles. For example, a podcast can be scripted and/or spontaneous, monologic and/or conversational, and contain code-switching.

There are various challenges and shortcomings associated with conventional approaches to SLI, including (1) being restricted to a certain language family or a small group of languages, (2) being trained on scripted spoken data that may not generalize to conversational and/or spontaneous spoken data, (3) not generalizing to code-switching audio (e.g., a speaker alternating between languages and/or dialects within a single conversation), and (4) being restricted to short audio and not generalizing well to long audio, such as podcasts, that may contain non-speech content (e.g., silence, music, and laughter). For example, approaches that rely on acoustic features (such as Mel-frequency Cepstral Coefficient or log-Mel spectrogram) or semantic audio embeddings (such as Wav2Vec embeddings) for spoken language identification may perform poorly for audio with multiple speakers using different languages or when one speaker switches between different languages.

The present disclosure includes systems and models that are lightweight (e.g., reduced number of parameters) and fast-to-train, such as a multi-class machine learning (ML) classifier. For example, a model may be configured to take a speaker embedding as input (e.g., a speaker embedding for an audio content item) and predict the language (e.g., a language and dialect) for the audio content item. The systems and methods described herein may leverage an average speaker embedding for predicting a language label of a content item (e.g., the dominant language for the content item). The models described herein may also be configured to perform audio tagging at a finer granularity (e.g., speaker-level or sentence-level). In this way the systems described herein can capture scenarios where code-switching occurs.

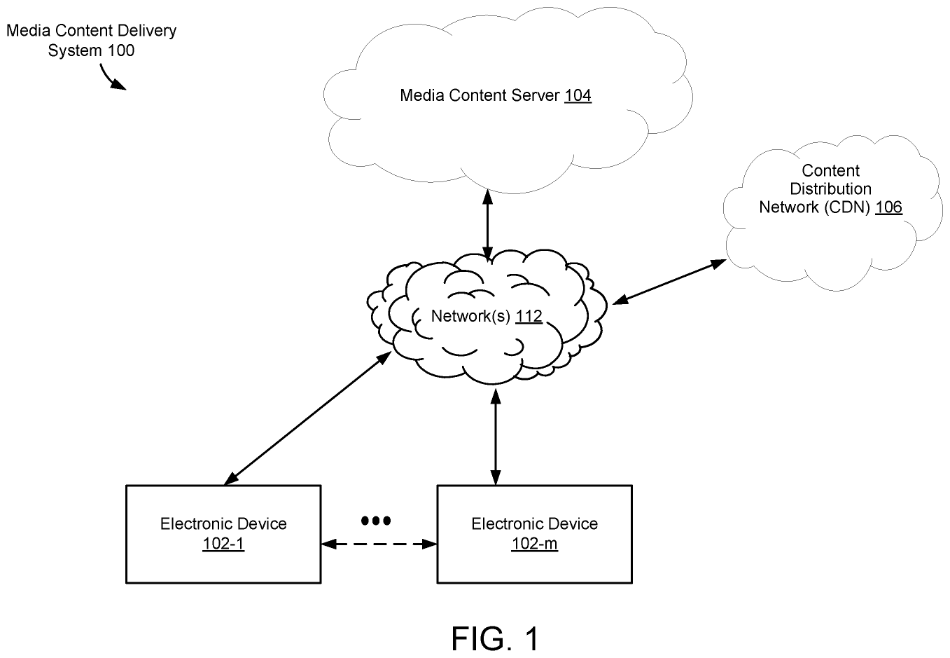

Turning now to the figures, FIG. 1 is a block diagram illustrating a media content delivery system 100 in accordance with some embodiments. The media content delivery system 100 includes one or more electronic devices 102 (e.g., electronic device 102-1 to electronic device 102-m, where m is an integer greater than one), one or more media content servers 104, and/or one or more content distribution networks (CDNs) 106. The one or more media content servers 104 are associated with (e.g., at least partially compose) a media-providing service. The one or more CDNs 106 store and/or provide one or more content items (e.g., to electronic devices 102). In some embodiments, the CDNs 106 are included in the media content servers 104. One or more networks 112 communicably couple the components of the media content delivery system 100. In some embodiments, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 is a personal computer, mobile electronic device, wearable computing device, laptop computer, tablet computer, mobile phone, feature phone, smart phone, an infotainment system, digital media player, a speaker, television (TV), and/or any other electronic device capable of presenting media content (e.g., controlling playback of media items, such as music tracks, podcasts, videos, etc.). Electronic devices 102 may connect to each other wirelessly and/or through a wired connection (e.g., directly through an interface, such as an HDMI interface). In some embodiments, electronic devices 102-1 and 102-m are the same type of device (e.g., electronic device 102-1 and electronic device 102-m are both speakers). Alternatively, electronic device 102-1 and electronic device 102-m include two or more different types of devices.

In some embodiments, electronic devices 102-1 and 102-m send and receive media-control information through network(s) 112. For example, electronic devices 102-1 and 102-m send media control requests (e.g., requests to play music, podcasts, movies, videos, or other media items, or playlists thereof) to media content server 104 through network(s) 112. Additionally, electronic devices 102-1 and 102-m, in some embodiments, also send indications of media content items to media content server 104 through network(s) 112. In some embodiments, the media content items are uploaded to electronic devices 102-1 and 102-m before the electronic devices forward the media content items to media content server 104.

In some embodiments, electronic device 102-1 communicates directly with electronic device 102-m (e.g., as illustrated by the dotted-line arrow), or any other electronic device 102. As illustrated in FIG. 1, electronic device 102-1 is able to communicate directly (e.g., through a wired connection and/or through a short-range wireless signal, such as those associated with personal-area-network (e.g., BLUETOOTH/BLE) communication technologies, radio-frequency-based near-field communication technologies, infrared communication technologies, etc.) with electronic device 102-m. In some embodiments, electronic device 102-1 communicates with electronic device 102-m through network(s) 112. In some embodiments, electronic device 102-1 uses the direct connection with electronic device 102-m to stream content (e.g., data for media items) for playback on the electronic device 102-m.

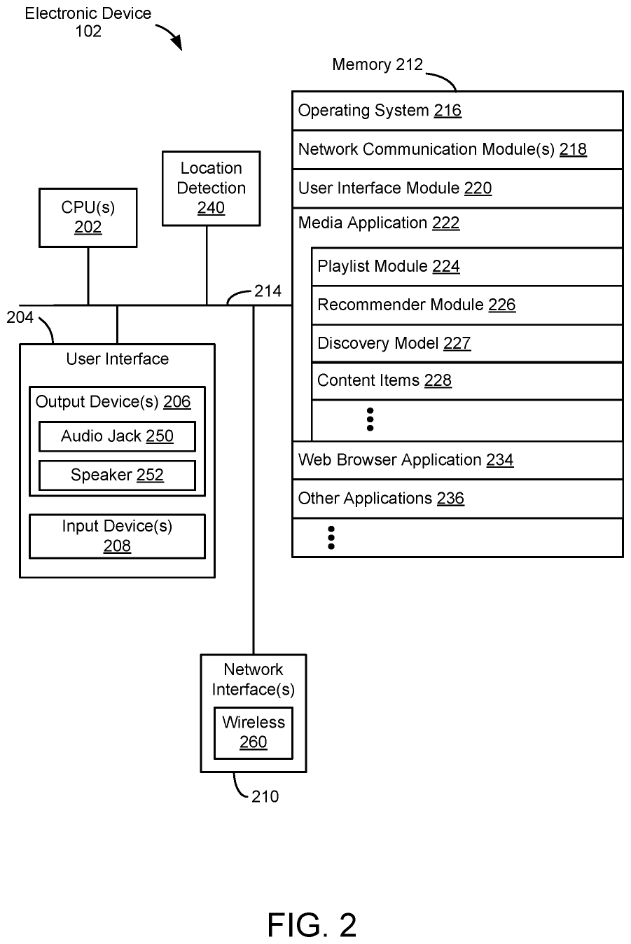

In some embodiments, electronic device 102-1 and/or electronic device 102-m include a media application 222 (FIG. 2) that allows a respective user of the respective electronic device to upload (e.g., to media content server 104), browse, request (e.g., for playback at the electronic device 102), and/or present media content (e.g., control playback of music tracks, playlists, videos, etc.). In some embodiments, one or more media content items are stored locally by an electronic device 102 (e.g., in memory 212 of the electronic device 102, FIG. 2). In some embodiments, one or more media content items are received by an electronic device 102 in a data stream (e.g., from the CDN 106 and/or from the media content server 104). The electronic device(s) 102 are capable of receiving media content (e.g., from the CDN 106) and presenting the received media content. For example, electronic device 102-1 may be a component of a network-connected audio/video system (e.g., a home entertainment system, a radio/alarm clock with a digital display, or an infotainment system of a vehicle). In some embodiments, the CDN 106 sends media content to the electronic device(s) 102.

In some embodiments, the CDN 106 stores and provides media content (e.g., media content requested by the media application 222 of electronic device 102) to electronic device 102 via the network(s) 112. Content (also referred to herein as “media items,” “media content items,” and “content items”) is received, stored, and/or served by the CDN 106. In some embodiments, content includes audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2- or 3-dimensional graphics-based computer games, etc.), or any combination of content types (e.g., web pages that include any combination of the foregoing types of content or other content not explicitly listed). In some embodiments, content includes one or more audio media items (also referred to herein as “audio items,” “tracks,” and/or “audio tracks”).

In some embodiments, media content server 104 receives media requests (e.g., commands) from electronic devices 102. In some embodiments, media content server 104 includes a voice API, a connect API, and/or key service. In some embodiments, media content server 104 validates (e.g., using key service) electronic devices 102 by exchanging one or more keys (e.g., tokens) with electronic device(s) 102.

In some embodiments, media content server 104 and/or CDN 106 stores one or more playlists (e.g., information indicating a set of media content items). For example, a playlist is a set of media content items defined by a user and/or defined by an editor associated with a media-providing service. The description of the media content server 104 as a “server” is intended as a functional description of the devices, systems, processor cores, and/or other components that provide the functionality attributed to the media content server 104. It will be understood that the media content server 104 may be a single server computer, or may be multiple server computers. Moreover, the media content server 104 may be coupled to CDN 106 and/or other servers and/or server systems, or other devices, such as other client devices, databases, content delivery networks (e.g., peer-to-peer networks), network caches, and the like. In some embodiments, the media content server 104 is implemented by multiple computing devices working together to perform the actions of a server system (e.g., cloud computing).

FIG. 2 is a block diagram illustrating an electronic device 102 (e.g., electronic device 102-1 and/or electronic device 102-m, FIG. 1), in accordance with some embodiments. The electronic device 102 includes one or more central processing units (CPU(s), e.g., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204, including output device(s) 206 and/or input device(s) 208. In some embodiments, the input devices 208 include a keyboard, mouse, or track pad. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., output device(s) 206) include a speaker 252 (e.g., speakerphone device) and/or an audio jack 250 (or other physical output connection port) for connecting to speakers, earphones, headphones, or other external listening devices. Furthermore, some electronic devices 102 use a microphone and voice recognition device to supplement or replace the keyboard. Optionally, the electronic device 102 includes an audio input device (e.g., a microphone) to capture audio (e.g., speech from a user).

Optionally, the electronic device 102 includes a location-detection device 240, such as a global navigation satellite system (GNSS) (e.g., GPS (global positioning system), GLONASS, Galileo, BeiDou) or other geo-location receiver, and/or location-detection software for determining the location of the electronic device 102 (e.g., module for finding a position of the electronic device 102 using trilateration of measured signal strengths for nearby devices).

In some embodiments, the one or more network interfaces 210 include wireless and/or wired interfaces for receiving data from and/or transmitting data to other electronic devices 102, a media content server 104, a CDN 106, and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, the one or more network interfaces 210 include a wireless interface 260 for enabling wireless data communications with other electronic devices 102, media presentations systems, and/or other wireless (e.g., Bluetooth-compatible) devices (e.g., for streaming audio data to the media presentations system of an automobile). Furthermore, in some embodiments, the wireless interface 260 (or a different communications interface of the one or more network interfaces 210) enables data communications with other WLAN-compatible devices (e.g., a media presentations system) and/or the media content server 104 (via the one or more network(s) 112, FIG. 1).

In some embodiments, electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the electronic device 102 to other computing devices (e.g., media presentation system(s), media content server 104, and/or other client devices) via the one or more network interface(s) 210 (wired or wireless) connected to one or more network(s) 112;
a user interface module 220 that receives commands and/or inputs from a user via the user interface 204 (e.g., from the input devices 208) and provides outputs for playback and/or display on the user interface 204 (e.g., the output devices 206);
a media application 222 (e.g., an application for accessing a media-providing service of a media content provider associated with media content server 104) for uploading, browsing, receiving, processing, presenting, and/or requesting playback of media (e.g., media items). In some embodiments, media application 222 includes a media player, a streaming media application, and/or any other appropriate application or component of an application. In some embodiments, media application 222 is used to monitor, store, and/or transmit (e.g., to media content server 104) data associated with user behavior. In some embodiments, media application 222 also includes the following modules (or sets of instructions), or a subset or superset thereof:
   a playlist module 224 for storing sets of media items for playback in a predefined order;
   a recommender module 226 for identifying and/or displaying recommended media items to include in a playlist;
   a discovery model 227 for identifying and presenting media items to a user;
   a content items module 228 for storing media items, including audio items such as podcasts and songs, for playback and/or for forwarding requests for media content items to the media content server;
a web browser application 234 for accessing, viewing, and interacting with web sites; and
other applications 236, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

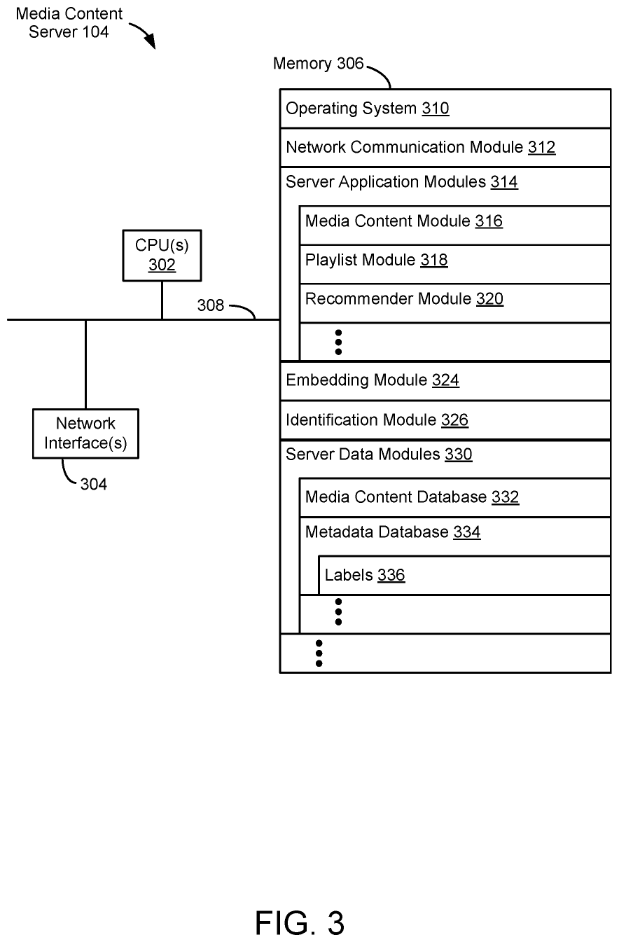

FIG. 3 is a block diagram illustrating a media content server 104, in accordance with some embodiments. The media content server 104 typically includes one or more central processing units/cores (CPUs) 302, one or more network interfaces 304, memory 306, and one or more communication buses 308 for interconnecting these components.

Memory 306 includes high-speed random-access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof:
an operating system 310 that includes procedures for handling various basic system services and for performing hardware-dependent tasks;
a network communication module 312 that is used for connecting the media content server 104 to other computing devices via one or more network interfaces 304 (wired or wireless) connected to one or more networks 112;
one or more server application modules 314 for performing various functions with respect to providing and managing a content service, the server application modules 314 including, but not limited to, one or more of:
   a media content module 316 for storing one or more media content items and/or sending (e.g., streaming), to the electronic device, one or more requested media content item(s);
   a playlist module 318 for storing and/or providing (e.g., streaming) sets of media content items to the electronic device; and
   a recommender module 320 for determining and/or providing recommendations for a playlist;
an embedding module 324 for generating an embedding signal from audio content (e.g., a VggVox embedder);
a language identification module 326 for identifying languages in audio content (e.g., using the embedding signals from the embedding module 324). In some embodiments, the language identification module 326 includes one or more models; and
one or more server data module(s) 330 for handling the storage of and/or access to media items and/or metadata relating to the media items; in some embodiments, the one or more server data module(s) 330 include:
   a media content database 332 for storing media items; and
   a metadata database 334 for storing metadata relating to the media items, such as a genre associated with the respective media items. In some embodiments, the metadata database includes one or more labels 336 for the respective media items.

In some embodiments, the media content server 104 includes web or Hypertext Transfer Protocol (HTTP) servers, File Transfer Protocol (FTP) servers, as well as web pages and applications implemented using Common Gateway Interface (CGI) script, PUP Hyper-text Preprocessor (PUP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (e.g., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above.

Although FIG. 3 illustrates the media content server 104 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. In some embodiments, media content database 332 and/or metadata database 334 are stored on devices (e.g., CDN 106) that are accessed by media content server 104. The actual number of servers used to implement the media content server 104, and how features are allocated among them, will vary from one implementation to another and, optionally, depends in part on the amount of data traffic that the server system handles during peak usage periods as well as during average usage periods.

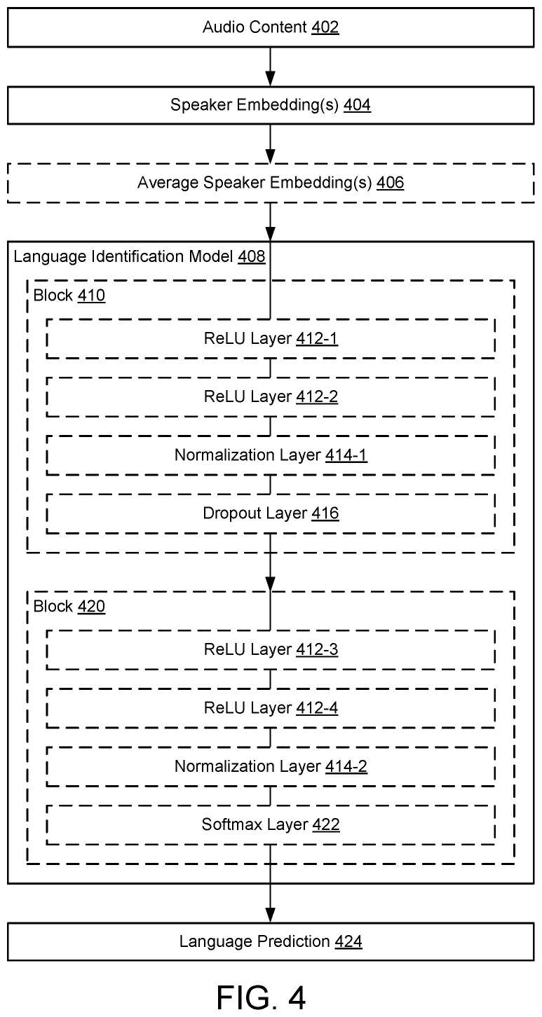

FIG. 4 is a block diagram illustrating a language identification system in accordance with some embodiments. One or more speaker embeddings 404 are generated from audio content 402. In some embodiments, the audio content 402 is a podcast episode or segment (e.g., a chapter or clip). In some embodiments, the speaker embeddings 404 are VggVox speaker embeddings. In some embodiments, the speaker embeddings 404 are generated via a speaker diarization process.

In some embodiments, one or more average speaker embeddings 406 are generated based on the speaker embedding(s) 404. In some embodiments, the average speaker embedding(s) 406 include an average speaker embedding for the entire audio content 402. In some embodiments, the average speaker embedding(s) 406 include a respective average speaker embedding for each speaker in the audio content 402. In some embodiments, the average speaker embedding(s) 406 include a respective average speaker embedding for each identified speaker region (e.g., a region with one specific person speaking) in the audio content 402. In some embodiments, other types of aggregated speaker embeddings (e.g., embeddings weighted by speaker identity or role) are generated and used in addition to, or alternatively to, the average speaker embedding(s) 406.

For example, a raw waveform for an audio file (e.g., for a podcast) is extracted and re-sampled (e.g., at 16 kilohertz). In this example, speaker diarization is performed (e.g., as described in U.S. patent application Ser. No. 17/932,249) on the re-sampled waveform to generate a series of speaker embedding vectors (e.g., 512-dimensional VggVox embedding vectors), where each speaker embedding vector corresponds to one identified speaker region (e.g., a region of one specific speaker talking). In this example, a z-score normalization is performed across the generated speaker embeddings for the audio file, and an average is taken to obtain a single average speaker embedding for the audio file. The average speaker embedding in this example is the input to the language identification model 408 for training and/or inference.

The speaker embedding(s) 404 and/or the average speaker embedding(s) 406 are input into a language identification model 408. In some embodiments, the language identification model 408 includes one or more blocks (e.g., the blocks 410 and 420 in FIG. 4). In the example of FIG. 4, the block 410 includes multiple rectified linear unit (ReLU) layers 412 (e.g., layers 412-1 and 412-2), a normalization layer 414-1, and a dropout layer 416. The block 420 in FIG. 4 includes multiple ReLU layers 412 (e.g., layers 412-3 and 412-4), a normalization layer 414-2, and a softmax layer 422. The language identification model 408 outputs a language prediction 424. In some embodiments, the language identification model 408 outputs a respective language prediction for each speaker embedding 404 and/or average speaker embedding 406. In some embodiments, the language prediction is made with respect to the same region over the timeline as the speaker embedding that is input into the language identification module (e.g., over a specific speaker region and/or over the entire audio). Such a language prediction can be regarded as the dominant language spoken in the region, and therefore, by varying the granularity of the input region over the timeline, the output language prediction also has different levels of granularity (e.g., over a specific speaker region and/or over the entire audio). In some embodiments, the language identification model 408 includes more or less blocks and/or more or less layers. Generally, adding blocks and/or layers reduces speed (e.g., latency) of the language identification model.

For example, after generating the average speaker embedding as an input feature, it is input into the language identification model 408 (e.g., a multi-class FNN model for spoken language identification). As an example, the language identification model 408 includes two similar blocks of layers, where each block includes two dense layers (e.g., ReLU layers) followed by a layer of batch normalization and a layer of either dropout or softmax calculation.

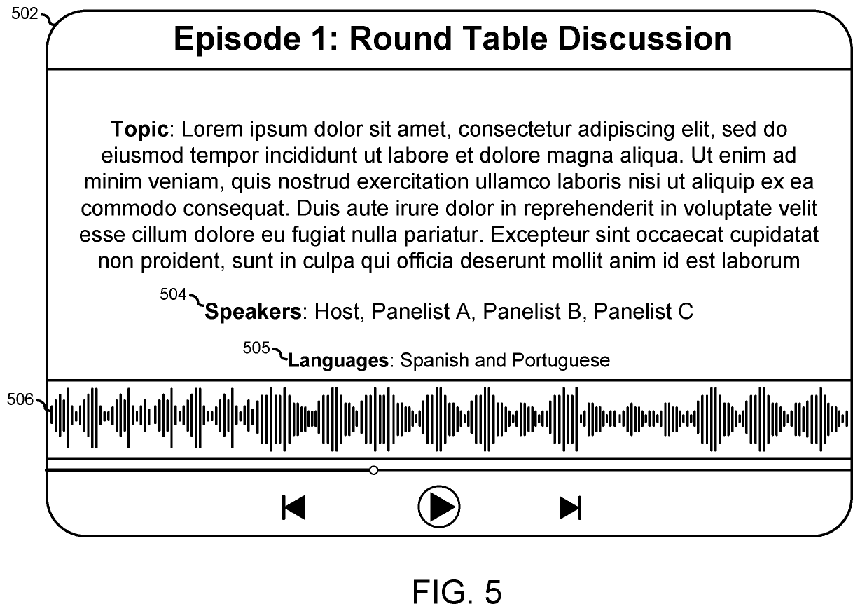

FIG. 5 illustrates a user interface 502 for media content in accordance with some embodiments. The user interface 502 includes information about a podcast episode with speakers 504 that include a host and panelists A, B, and C. The user interface 502 also includes languages 505 identified in the podcast episode (e.g., Spanish and Portuguese) and an audio timeline 506. In some embodiments, the languages 505 are identified based on the audio of the episode. For example, speaker embeddings are generated for each of the speakers 504 and the languages 505 are identified based on analysis of the speaker embeddings (e.g., using the language identification model 408). In some embodiments, only a single language is identified for the episode (e.g., the most used (dominant) language). In some embodiments, the audio timeline 506 includes annotation to indicate when each language 505 is being spoken during the episode.

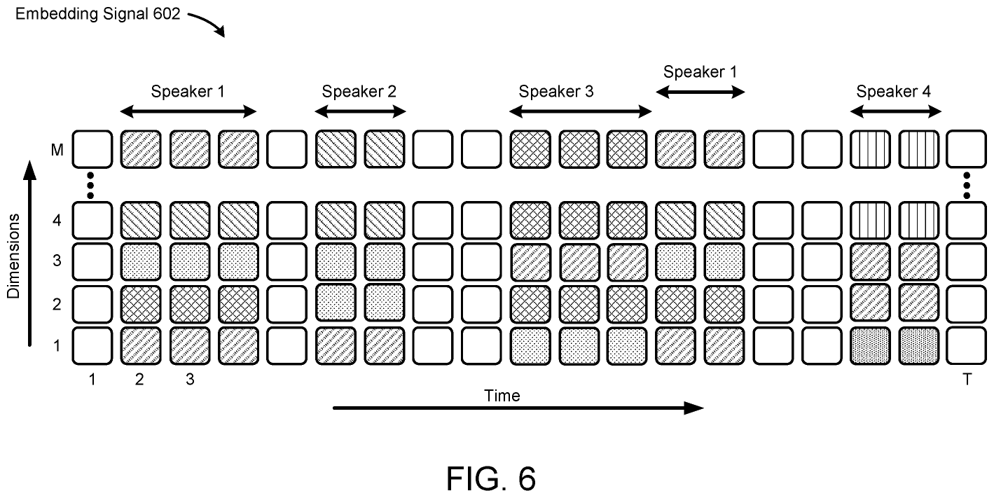

FIG. 6 is a block diagram illustrating an embedding signal 602 (e.g., a speaker embedding) in accordance with some embodiments. The embedding signal 602 corresponds to an audio content item (e.g., the audio content 402) and includes M-dimensional embeddings (e.g., 256, 512, or 1028 dimensions) and T time periods. The embeddings correspond to multiple speakers in the corresponding audio content (e.g., speakers 1, 2, 3, and 4) and each time period has a corresponding embedding. In some embodiments, the embedding signal 602 is composed of real numbers (e.g., positive and negative numbers).

In some embodiments, a sequence of M-dimensional vectors is generated for an audio recording, e.g., using a pre-trained VggVox embedder. In some embodiments, the M-dimensional vectors include one or more negative numbers. In some embodiments, embedder is able to capture not only the acoustic characteristics, but also dialectal and stylistic speech characteristics. This allows for the use of vector similarity metrics (e.g., cosine similarity) to identify whether two speech segments are from the same speaker. In some embodiments, the vectors have the characteristic of adhering to a linearity constraint. For example, a VggVox embedding of an audio chunk from speaker S₁ of length p concatenated with an audio chunk from speaker S₂ of length q is approximately equal to its weighted arithmetic average.

In some embodiments, a recording is segmented into a series of overlapping chunks by sliding a window (e.g., a 4, 6, or 8 second window) over the recording with a variable step size (e.g., a variable step size of 1 second or less). In some embodiments, the step size is set so as to yield at least 3,600 chunks per hour of audio. In some embodiments, a vector is computed for each chunk using a pretrained VggVox model.

In some embodiments, an algorithm (e.g., MobileNet2) is utilized to detect non-speech regions in the recording. In some embodiments, the vectors for non-speech regions are set to zero. In some embodiments, the sequence of the vectors for the recording are arranged into a matrix referred to as an embedding signal (e.g., the embedding signal 602). In some embodiments, the embedding signal is defined as ε= [symbol] so that vectors from each of the T timesteps are represented in the columns of the matrix. In some embodiments, the embedding signal is normalized such that the columns are unit vectors.

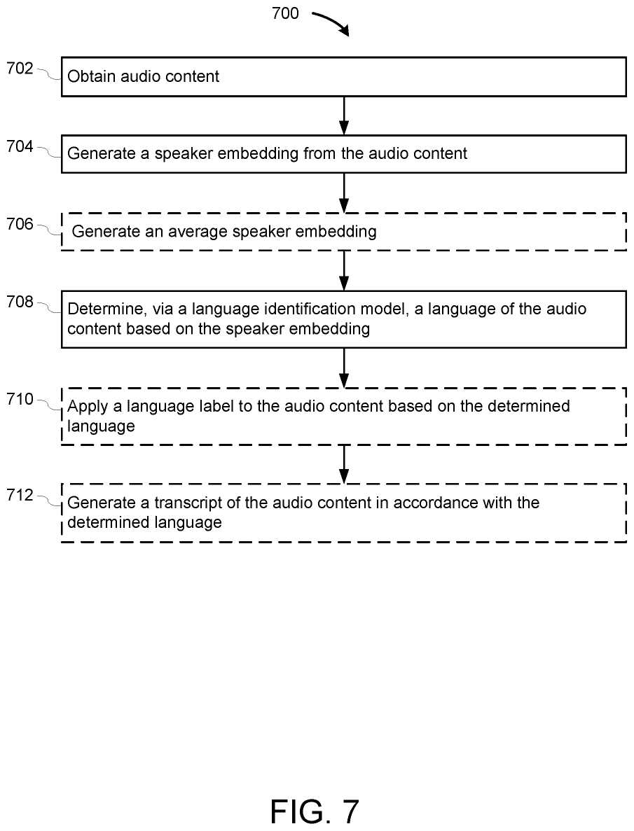

FIG. 7 is a flow diagram illustrating a method 700 for language identification in accordance with some embodiments. The method 700 may be performed at a computing system (e.g., media content server 104 and/or electronic device(s) 102) having one or more processors and memory storing instructions for execution by the one or more processors. In some embodiments, the method 700 is performed by executing instructions stored in the memory (e.g., memory 212, FIG. 2 and/or memory 306, FIG. 3) of the computing system. In some embodiments, the method 700 is performed by a combination of the server system (e.g., including media content server 104 and CDN 106) and a client device.

The system obtains (702) audio content (e.g., the audio content 402). In some embodiments, the audio content includes one or more podcast episodes, audio books, and/or shows (and/or segments thereof). In some embodiments, the audio content is an audio recording (e.g., without any content-related metadata). As another example, the system obtains a recording from a meeting or conversation. In some embodiments, the system obtains the audio recording from a media database (e.g., the media content database 332).

The system generates (704) a speaker embedding (e.g., the speaker embedding(s) 404) from the audio content. For example, the system generates the speaker embedding using a pretrained speaker embedder (e.g., a VggVox embedder). For example, the system generates the speaker embedding using the embedding module 324.

In some embodiments, the system generates (706) an average speaker embedding (e.g., the average speaker embedding(s) 406). In some embodiments, the system generates an average speaker embedding for the audio content. In some embodiments, the system identifies a plurality of speakers in the audio content and generates an average speaker embedding for each identified speaker. In some embodiments, the system generates an average speaker embedding for each identified speaker region over the timeline.

The system determines (708), via a language identification model (e.g., the model 408), a language of the audio content based on the speaker embedding. In some embodiments, the language identification model includes one or more blocks (e.g., the blocks 410 and 420). In some embodiments, the language identification model is a feedforward neural network (FNN).

In some embodiments, the system applies (710) a language label to the audio content based on the determined language (e.g., the languages 505 for the episode in FIG. 5). In some embodiments, the system applies a language label for each speaker of a plurality of speakers. In some embodiments, the system applies a language label for each identified speaker region over the timeline.

In some embodiments, the system generates (712) a transcript of the audio content in accordance with the determined language. In some embodiments, the system performs automatic speech recognition (ASR) in accordance with the determined language and generates the transcript based on the ASR. In some embodiments, the system performs other speech tasks, such as speech translation, in accordance with the determined language.

Although FIG. 7 illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

(A1) In one aspect, some embodiments include a method (e.g., the method 700) of language identification. The method is performed at a computing device (e.g., the electronic device 102 or the media content server 104) having one or more processors and memory. The method includes: (i) obtaining audio content (e.g., from a user or database); (ii) generating a speaker embedding (e.g., the embedding signal 602) from the audio content (e.g., using the embedding module 324); and (iii) determining, via a language identification model (e.g., the language identification model 408 and/or a component of the identification module 326), a language of the audio content based on the speaker embedding (e.g., the language prediction 424).

In some embodiments, the speaker embedding includes a plurality of embeddings, each embedding of the plurality of embeddings corresponding to a time period of the audio content item. For example, the embedding signal 602 includes a M-dimensional embedding for each time period of the T time periods. In some embodiments, the embedder is trained using utterances from a variety of speakers in various contexts and situations so as to capture acoustic, dialectal, and stylistic speech characteristics.

In some embodiments, generating the speaker embedding includes detecting non-speech regions in the audio recording and setting the signal to zero for the non-speech regions. For example, the non-speech regions are detected using a trained neural network (e.g., a convolutional neural network).

(A2) In some embodiments of A1, the method further includes generating an average speaker embedding (e.g., the average speaker embedding(s) 406) by aggregating two or more speaker embeddings from the audio content, where the language of the audio content is determined based on the average speaker embedding. In some embodiments, the average speaker embedding is generated using the embedding module 324.

(A3) In some embodiments of A1 or A2, determining, via a language identification model, the language of the audio content includes inputting the speaker embedding to the language identification model.

(A4) In some embodiments of any of A1-A3, the method further includes: (i) performing speaker diarization on the audio content to distinguish a plurality of speakers (and/or a set of speaker regions); and (ii) generating one or more aggregated speaker embeddings by aggregating respective speaker embeddings for each speaker of the plurality of speakers (and/or each speaker region in the set of speaker regions), where the language of the audio content is determined based on at least one of the one or more aggregated speaker embeddings. In some embodiments, determining, via a language identification model, the language of the audio content includes inputting an average speaker embedding to the language identification model. For example, a z-score normalization is performed across the generated speaker embeddings for the audio content, and an average is taken to obtain an average speaker embedding. In some embodiments, the system (1) performs speaker diarization on the audio content to generate a series of speaker embeddings, (2) determines an average of the speaker embeddings, and (3) provides the average speaker embedding into a multi-class feedforward neural network (FNN) to predict a language label of the audio content.

(A5) In some embodiments of any of A1-A4, language identification model is trained with labeled audio content (e.g., labeled per episode and/or per show). For example, the model is trained with podcast audio data in a variety of languages and dialects (e.g., with manually-applied language labels). In some embodiments, the labeled audio content includes metadata language labels provided with the audio content (e.g., when the audio content is uploaded to the media content database 332).

(A6) In some embodiments of any of A1-A5, the language identification model is, or includes, a feedforward neural network (e.g., a multi-class feedforward neural classifier). In some embodiments, the feedforward neural network includes two or more blocks of layers, where each block includes one or more dense layers (e.g., ReLU layers), a normalization layer, and a dropout or softmax layer.

(A7) In some embodiments of any of A1-A6, the language identification model includes a plurality of rectified linear unit (ReLU) layers and a plurality of normalization layers. For example, each block of layers includes one or more ReLU layers (e.g., the ReLU layers 412) and a normalization layer (e.g., the normalization layer 414-1). In some embodiments, the language identification model comprises one or more dropout layers and/or one or more softmax layers.

(A8) In some embodiments of any of A1-A7, the method further includes applying a language label to the audio content based on the determined language. In some embodiments, a user interface is provided to a user to allow playback of the audio content along with indication the languages spoken in the audio content (e.g., as illustrated in FIG. 5).

(A9) In some embodiments of any of A1-A8, the method further includes generating a transcript of the audio content in accordance with the determined language.

(A10) In some embodiments of any of A1-A9, the method further includes: (i) performing speaker diarization on the audio content to distinguish a plurality of speaker regions; (ii) generating one or more aggregated speaker embeddings by aggregating respective speaker embeddings for each speaker region of the plurality of speaker regions; where the language of the audio content is determined based on at least one of the one or more aggregated speaker embeddings (e.g., corresponding to the whole audio item and/or respective speakers or speaker regions).

In another aspect, some embodiments include a computing system including one or more processors and memory coupled to the one or more processors, the memory storing one or more programs configured to be executed by the one or more processors, the one or more programs including instructions for performing any of the methods described herein (e.g., the method 700 or A1-A10 above).

In yet another aspect, some embodiments include a non-transitory computer-readable storage medium storing one or more programs for execution by one or more processors of a computing system, the one or more programs including instructions for performing any of the methods described herein (e.g., the method 700 or A1-A10 above).

It will also be understood that, although the terms first, second, etc. are, in some instances, used herein to describe various elements, these elements should not be limited by these terms. These terms are used only to distinguish one element from another. For example, a first electronic device could be termed a second electronic device, and, similarly, a second electronic device could be termed a first electronic device, without departing from the scope of the various described embodiments. The first electronic device and the second electronic device are both electronic devices, but they are not the same electronic device.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A method of identifying a language in audio content, the method comprising:
obtaining audio content;
generating a speaker embedding from the audio content; and
determining, via a language identification model, a language of the audio content based on the speaker embedding.

2. The method of claim 1, further comprising generating an average speaker embedding by aggregating two or more speaker embeddings from the audio content, wherein the language of the audio content is determined based on the average speaker embedding.

3. The method of claim 1, wherein determining, via a language identification model, the language of the audio content comprises inputting the speaker embedding to the language identification model.

4. The method of claim 1, further comprising:
performing speaker diarization on the audio content to distinguish a plurality of speakers;
generating one or more aggregated speaker embeddings by aggregating respective speaker embeddings for each speaker of the plurality of speakers; and
wherein the language of the audio content is determined based on at least one of the one or more aggregated speaker embeddings.

5. The method of claim 1, wherein language identification model is trained with labeled audio content.

6. The method of claim 1, wherein the language identification model comprises a feedforward neural network.

7. The method of claim 1, wherein the language identification model comprises a plurality of rectified linear unit (ReLU) layers and a plurality of normalization layers.

8. The method of claim 1, further comprising applying a language label to the audio content based on the determined language.

9. The method of claim 1, further comprising generating a transcript of the audio content in accordance with the determined language.

10. A computing system, comprising:
one or more processors;
memory; and
one or more programs stored in the memory and configured for execution by the one or more processors, the one or more programs comprising instructions for:
obtaining audio content;
generating a speaker embedding from the audio content; and
determining, via a language identification model, a language of the audio content based on the speaker embedding.

11. The system of claim 10, wherein the one or more programs further comprise instructions for generating an average speaker embedding by aggregating two or more speaker embeddings from the audio content, wherein the language of the audio content is determined based on the average speaker embedding.

12. The system of claim 10, wherein the one or more programs further comprise instructions for:
performing speaker diarization on the audio content to distinguish a plurality of speakers;
generating one or more aggregated speaker embeddings by aggregating respective speaker embeddings for each speaker of the plurality of speakers; and
wherein the language of the audio content is determined based on at least one of the one or more aggregated speaker embeddings.

13. The system of claim 10, wherein the language identification model comprises a feedforward neural network.

14. The system of claim 10, wherein the one or more programs further comprise instructions for applying a language label to the audio content based on the determined language.

15. The system of claim 10, wherein the one or more programs further comprise instructions for generating a transcript of the audio content in accordance with the determined language.

16. A non-transitory computer-readable storage medium storing one or more programs configured for execution by a computing device having one or more processors and memory, the one or more programs comprising instructions for:
obtaining audio content;
generating a speaker embedding from the audio content; and
determining, via a language identification model, a language of the audio content based on the speaker embedding.

17. The non-transitory computer-readable storage medium of claim 16, wherein the one or more programs further comprise instructions for generating an average speaker embedding by aggregating two or more speaker embeddings from the audio content, wherein the language of the audio content is determined based on the average speaker embedding.

18. The non-transitory computer-readable storage medium of claim 16, wherein the one or more programs further comprise instructions for:
performing speaker diarization on the audio content to distinguish a plurality of speakers;
generating one or more aggregated speaker embeddings by aggregating respective speaker embeddings for each speaker of the plurality of speakers; and
wherein the language of the audio content is determined based on at least one of the one or more aggregated speaker embeddings.

19. The non-transitory computer-readable storage medium of claim 16, wherein the language identification model comprises a feedforward neural network.

20. The non-transitory computer-readable storage medium of claim 16, wherein the one or more programs further comprise instructions for applying a language label to the audio content based on the determined language.
